(19) United States
(12) Patent Application Publication
(10) Pub. No.: US 2006/0066570 A1
(43) Pub. Date: Mar. 30, 2006

(54) Pointing device and method

(76) Inventor: Timothy M. Trifilo, Poughkeepsie, NY (US)

Correspondence Address: Andrew J. Wojnicki, Jr.;Intellectual Property Law, IBM Corporation, MS P386, 2455 South Road, Poughkeepsie, NY, 12601, US

(21) Appl. No.: 10/950,785

(22) Filed: Sep. 27, 2004

(51) Int. Cl. G09G 5/08

(52) U.S. Cl. 345/157

(57) ABSTRACT

A method and device for an enhanced pointing device is provided. The pointing device includes an encoder and a pressure sensor circuit. The encoder is operable to detect a directional user input. The pressure circuit includes a pressure sensor and a pressure detector having an off-state and an on-state. The encoder and the pressure circuit are in communication with a controller. The controller outputs a rate signal which varies in relation to an amount of pressure sensed by said pressure sensor and outputs a signal indicative of the on or off state of said pressure detector. Minimum and maximum speeds can be set for the rate. In addition, audio and/or tactile feedback can be provided.

### BACKGROUND OF THE INVENTION

The present invention is directed to a pointing device and corresponding method, such as for use with a computer or other device having an interactive visual display.

Pointing devices that can be used in conjunction with a computing environment have predated personal computers. An example of pointing devices are the hand-held devices such as joysticks that were used in early arcade type games. The advent of personal computers, however, have increased the popularity and the variety of such devices. The ever-increasing popularity of video games, no longer limited to arcade environments, have also caused popularity of such devices to increase. The increasing popularity of such devices has led not only to more variety, but to a greater level of sophistication of such devices. Some examples of such hand-held devices include the light pen, a stylus for a bit pad and the more popular computer mouse.

The computer mouse is probably the most common, and most popular form of pointing devices. It is used not only in conjunction with the personal computer, ranging from the portable computer to desktop varieties, but it is also used in conjunction with a variety of other computing devices such as video gaming devices, both of commercial arcade or home arcade varieties, medical instrumentation, and industrial automation devices.

The more common computer mouse currently used today is of the mechanical variety and operates on the basis of coordinates such as x and y coordinates. The most commonly used type comes in the form of a roller ball with sensors for sensing x and y movement. Some mechanical mouse arrangements also provide for buttons, as well as x and y directional sensors. Normally, the x and y directional inputs are analog inputs. However, the sensors can provide digital or binary outputs to a computing device, such as a microprocessor present in the computing environment. The computing device can then interpret the results via software, if desired. In fact, some computer software now allows movement of a mouse over a three dimensional graphics space and also allows movement by clicking the function button of the mouse.

Most mechanical mouse arrangements require the mouse to be connected to the computing environment via a wire. However, optical, radio, and sonic varieties are also known, which can be independent of direct wiring to the computer but must be placed somehow in processing communication with the computer. For example, in the case of the optical mouse, the mouse has to be in direct view of the computer. At the same time, a computer mouse of resistive nature is also known in which the computer mouse need not be in view of the computer.

FIG. 1 is a prior art illustration of the use of a hand-held computer mouse. As illustrated in FIG. 1, a basic mouse device is made up of different functional blocks, including an x-y position encoder 110 and a button press detector 120, as discussed above. The control processor 130 processes the output of the x-y position encoder 110 and the button press detector 120 to provide pointing device output information to the computer. Specifically, the control processor 130 handles functions including data framing, button debouncing and sensing, and position resolution. Through the use of an interface 140, the control processor 130 is itself in processing communication with the computing environment. In the illustrated example, the computing environment is represented by a personal desktop computer 150, while other computing devices are used as well.

The difficulty with most computer mouse and other pointing devices that exist in the prior art today, is that the extent of use adds to the wear and premature failure of these devices. For example, heavy use that typically occurs during game play or repetitive tasks can easily cause premature failure of mouse buttons. Currently, there are no solutions in existence to address and resolve this, other than to replace the entire pointing device. Consequently, there is a need for an improved method and device that can help prevent the premature failure of pointing device components, such as mouse buttons, that occurs due to excessive use associated with repetitive functions such as those used in a video game.

### SUMMARY OF THE INVENTION

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

A method and device for an enhanced pointing device is provided. The pointing device includes an encoder and a pressure sensor circuit. The encoder is operable to detect a directional user input. The pressure circuit includes a pressure sensor and a pressure detector having an off-state and an on-state. The encoder and the pressure circuit are in communication with a controller. The controller outputs a rate signal varying in relation to an amount of pressure sensed by said pressure sensor and a signal indicative of the on or off state of said pressure detector. In embodiments of the present invention, minimum and maximum speeds can be set for the rate. In addition, in other embodiments, audio or tactile feedback can be provided. In addition, in a preferred embodiment, an analog pressure sensor and a pulse generator are used as the pressure sensor.

### DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is a diagram illustrating a pointing device, as used with a computer, according to the prior art;

FIG. 2 is a block diagram illustrating a pointing device according to an embodiment of the invention; and

FIG. 3 is a diagram illustrating use of a pointing device according to an embodiment of the invention.

### DETAILED DESCRIPTION

The present invention is an improved apparatus and associated method of providing a computer pointing device, such as a computer mouse, that is designed specifically to reduce or entirely avoid wear and premature failure of these devices. The embodiments of the present invention provide a pointing device which facilitates a way in which repetitive tasks are performed. An apparatus and a method are further detailed for providing a variable speed button actuation via an analog pressure sensor in a platform independent environment, although in certain embodiments additional software can be added to the analog sensor to further enhance the operation of the pointing device. In one embodiment of the present invention, the functional enhancement of the present invention is implemented entirely in the firmware.

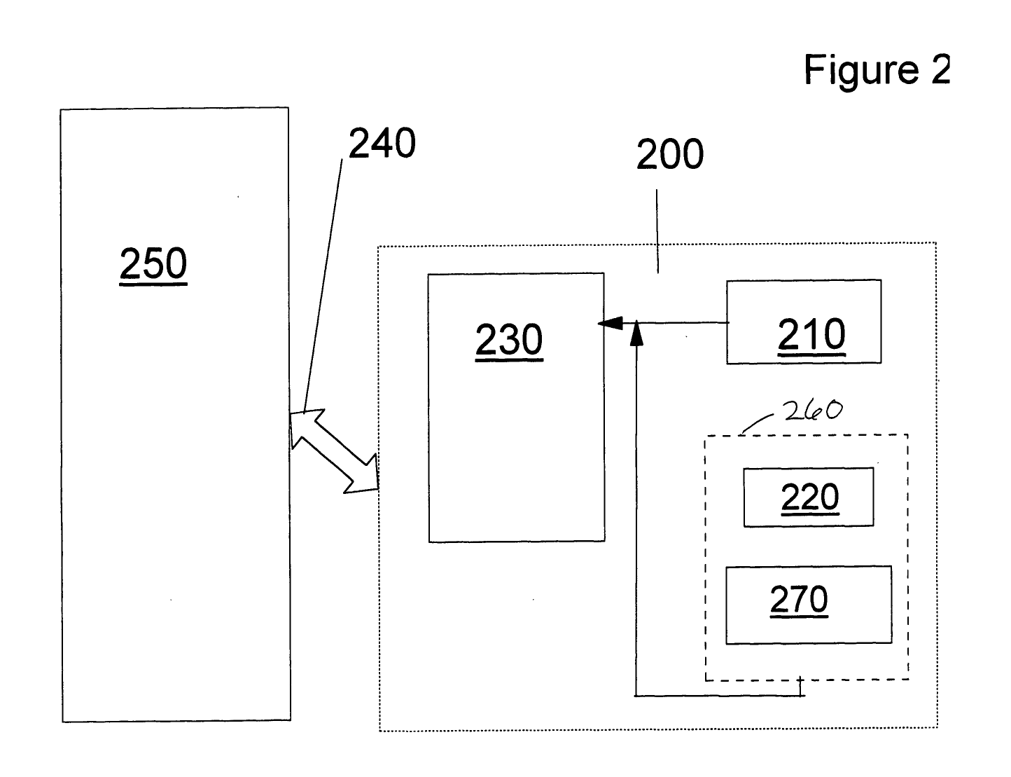

FIG. 2 is a block diagram illustrating one embodiment of the present invention. As illustrated in FIG. 2, a pointing device 200 includes an encoder 210 and a pressure circuit 260. The encoder 210 is operable to detect a directional user input. In the case of a mouse, the directional input will be in an x-y direction. while in another example, such as a joystick, the directional input can be rotational.

The pressure circuit 260 includes a pressure detector 270 and a pressure sensor 220. The pressure detector has an off-state and an on-state, the pressure detector being triggered, for example, by the depression of a button of a mouse or the squeezing of a joystick. The pressure circuit and the encoder are both in communication with a controller 230. The controller 230 provides output to a computing environment 250 through an interface 240. The computing environment can include, for example, a single computer, a video game machine or a network of computing nodes in processing communication with one another. The output of the controller 230 is a rate signal which varies in relation to an amount of pressure sensed by the pressure sensor 220 and a signal indicative of the on or off state of the pressure detector 270.

A more detailed example of a pointing device according to one embodiment is illustrated in FIG. 3. In the embodiment of FIG. 3, a computer mouse is illustrated as an example of a pointing device. However, as indicated, the use of a computer mouse as a pointing device is merely one example. The principles of the present invention can be as easily applied to other embodiments using other types of pointing devices.

In FIG. 3, a block diagram of the computer mouse 300 is provided. In this embodiment, the mouse 300 is illustrated in processing communication with a desktop computer 350, via an interface 340. The desktop computer in FIG. 3 is illustrative of the computing environment and can be either a stand-alone unit or used as a node in a network of nodes that comprise a computing environment.

Similar to the embodiment of FIG. 2, the mouse 300 includes a directional encoder 310 and a pressure circuit 360. The pressure circuit in this embodiment includes a button as a pressure detector and a pressure sensor, preferably being an analog pressure sensor. In one embodiment of the invention, the pressure sensor can also function as a pulse generator.

The pressure circuit 360 and the pressure encoder 310 are both in communication with a controller 330. In one embodiment of the present invention, the controller can even be a control processor that handles a variety of functions ranging from data framing, button debouncing, functions that involve sense and position resolution, and dynamic acceleration functions which allow for cursor movement at a greater than 1:1 ratio of mouse displacement to cursor movement.

It should be noted that the purpose of a pointing device, such as the mouse of FIG. 3, is to provide an interface through which user input can be translated into an operational function in the computer, such as the desktop computer 350 of FIG. 3. In many pointing devices, motion is used as user input. For example, in the case of the mouse of FIG. 3, the user input would take the form of changing the position of the mouse, which then gets translated into the position of a cursor on the computer screen. For example, the movement of the mouse is used to determine the movement of a cursor in a variety of applications such as word processing.

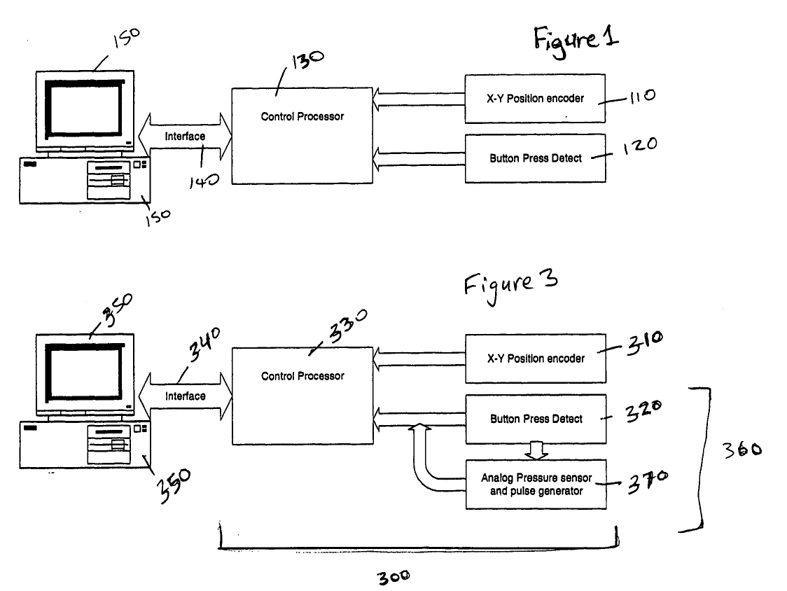

The function of the positional (i.e. x-y) encoder 310 is to electronically sense x and y movement as the user of the mouse moves the mouse device, whether the mouse is a traditional one having the ball underneath or one that has a roller ball which can be moved directly by the user. In cases of conventional pointing devices that primarily use motion as the determinative factor for user input, the movement of the device is predefined and the freedom of physical movement is correspondingly restricted. For example, a joystick senses user input which varies in rotary or linear degrees. In the example of the conventional computer mouse, as illustrated in FIG. 1, the movement is limited to two degrees of freedom in the plane of a mouse-pad or other surface, namely the x and y axes. In other words, the movement of the mouse in the x and y direction is related directly to the movement of a cursor on the computer screen. The cursor (or other similar designated marker) then moves directly in response to the movement of the pointing device.

However, the present invention does not limit the user input to that of movement alone. Other components are provided as part of the mouse device to allow greater user input. These added user input features are made possible by the use of the pressure detector, in this case referenced as a button press detector 320 and the analog sensor 370 which enables the user to provide additional input in other ways.

Any kind of electronic or mechanical device that functions based on user input has to consider user reaction to different situations arising from the operation of the device. For example, in operating an elevator, even though the pressing of the elevator button alone will retrieve the elevator to the desired floor at a given time, many users often wrongly feel that continuously pressing the elevator button speeds up the rate of dispatch. The same principle is applicable in computing environments, where processing speed is an important factor, such as in playing of video games. In such situations, the user often wrongfully assumes that the exertion of continuous force to the pointing device may speed up the rate of processing. Unfortunately, since it is not the pressure, but the direction of rotation that creates the corresponding cursor movement in such devices, these user behaviors only add to the wear of the pointing device. This undue wear further combines with the nature of use associated with many pointing devices that allow for repeated rotational movement of the device, such as in video games, to cause device failure as indicated earlier.

Taking these operational realities into consideration, the pressure sensor 370 is used to enable the user to provide an additional input when repeated tasks or other kinds of requests are needed. The sensor provides advantages associated with both rate and repeat control and positional control user input, in that a variable speed button actuation is provided via the use of the pressure sensor 370 and its interaction with button press detector 320. It should be noted, that in other embodiments of the present invention, buttons other than standard function mouse buttons can be used to provide enhanced functionality. Such buttons can also be triggered in a variety of ways, such as the through pressure or other arrangements. In either case, the buttons interface with the sensors of the pointing device. It also should be noted, that as in the case with most pointing devices as discussed earlier, the role of the buttons is to provide user selection of communication information sent to the host.

In a preferred embodiment, at least one sensor is implemented in processing communication with the button that is a pressure-sensitive analog sensor. For example, the analog pressure sensor may exhibit a varying electrical conductance that depends upon the amount of pressure applied to an associated button. The amount of pressure then determines which one of several readable states is to be communicated to the computer. The circuitry reads the states of the analog sensor and information representing the state or value of the sensor is communicated to the host. A user can select any of a plurality of selectable pressure levels associated with the analog sensor.

With reference to FIG. 3, these functions are provided by pressure sensors, preferably analog pressure sensors. These are illustrated in FIG. 3 as the pressure sensor and pulse generator 370. In the embodiment illustrated in FIG. 3, one or more buttons of the mouse can further be designed with a multi-stage stage switch to provide the selectable pressure levels. In a preferred embodiment, a two-stage switch can be provided to allow for two pressure levels selectable by the user. As an illustrative example, in one embodiment of the present invention, a light depression of the button would cause a typical directional related mouse click. Further depression of the button would enable the rapid repeating of the function at a frequency proportional to the amount of pressure applied to the button.

This embodiment of the present invention can be extended to other pointing devices, as indicated above. In another example, when the principles of the present invention are utilized with a joystick, the movement of the joystick can be compared to the trigger function of a button. In this regard, a light application of pressure to the joystick will provide the usual directional movement, namely either rotational or linear movement; whereas a further application of pressure will provide rapid repeat of the function again with a frequency proportional to the amount of pressure applied to the joystick. In case of the joystick or other types of pointing devices, multi-stage switches can also be implemented to provide a variety of different options to the user. For example, a steady pressure exerted in one positional direction of the joystick could mean the repetition of a different function than the application of pressure in a different position.

The concept discussed above applies equally to other pointing devices. For example, in a variety of pointing devices such as touch pads or even more sophisticated joysticks, depressible surfaces may be introduced that function as a button or a trigger. The depressible surface can then be connected to the circuitry of an analog sensor and multi-stage switches be implemented to trigger different types of functions. In this regard, a light touch may be used to trigger usual functions, while a persistent pressure can trigger a rapid repeat of the function, again with a frequency proportional to the amount of pressure applied to the surface.

Other similar examples also exist. For example, some of the mouse devices provided in conjunction with some notebook computers do not provide the same type of clicking function as a regular mouse. However, in recent years the traditional mouse click function is provided by use of special buttons on the keyboard of the notebook computer. While in these cases, the mouse can be considered a part of the keyboard, the principles of the present invention encompasses appropriately modified computer mice of such types, as well. Whether the mouse device is of the variety that only allows rotational movement by manipulating a button by fingers, or is provided in conjunction with a button for greater operational facility, the variable speed arrangement of the present allows the pressure sensor to be actuated by finger pressure on the main mouse device, the enhancer keyboard button or both.

The illustrative embodiment provided in FIG. 3 also shows interface 340. It should be noted that most mouse devices use well-established interfaces to communicate base functions such as positioning and button pressing with the computing environment. Perhaps, this is the reason why in most instances it is unnecessary to provide a device driver for one or various mouse devices, providing that they have no special interface features. The pointing device provided according to embodiments of the invention is also designed to be employed with any of the traditional mouse interfaces or other similar pointing device interfaces. However, the pointing device can also be operational if a special interface is provided that provides for special interface features.

In addition, it should also be noted that in some embodiments, additional software does not need to be installed on the computer to enable the above-described functions. However, in other embodiments of the invention, additional software can be installed on the computer to enhance the operability and to add to provided functions. In one embodiment, software can be implemented, for example, to set the minimum and maximum click repeat speeds for providing more precise control for a particular application. Such software can be arranged so that the minimum and maximum click repeat speeds can be universally set, or be changed and modified for each application.

Nonetheless, in one embodiment of the present invention, the upper and lower click repeat speed limits are set without the use of software. In this embodiment, the upper and lower speed limits are set with the use of a small potentiometer, which would require no software at all.

Furthermore, it will be appreciated that various computer software programs have also been developed which utilize various pointing devices to enhance the user experience. For example, various computer software programs have been developed which utilize a computer mouse as an input to permit the user to have a three dimensional graphics function by entering information such as dimensions regarding different surfaces of an object. This may be accomplished by moving the mouse over desired distances and clicking the function button of the mouse. A computer processor in the computing environment can then be programmed so as to provide the three dimensional renderings of an object.

While the discussion of the above-described embodiments is directed mostly to the use of very simple and traditional pointing devices, the principles of the present invention are also applicable to provide similar functions for more sophisticated pointing devices. In fact, the multi-speed actuation provided described in the foregoing can be combined with more sophisticated pointing devices to enable enhanced functions.

Pointing devices according to further embodiments of the invention are also enhanced by the addition of audio and/or tactile feedback. The purpose of feedback is to make the pointing device such as a mouse feel more like an extension of the user. Tactile feedback is used to provide user input to the environment upon actuation or de-actuation of a pressure-sensitive variable-conductance sensor. This concept can be carried further by allowing the feedback to be outputted back to the user by a solenoid, a speaker or a piezoelectric transducer, for example.

While the invention has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

1. A pointing device comprising:
an encoder operable to detect a directional user input;
a pressure circuit including a pressure sensor and a pressure detector having an off-state and an on-state;
a controller in communication with said encoder and said pressure circuit;
said controller outputting a rate signal varying in relation to an amount of pressure sensed by said pressure sensor, said controller further outputting a signal indicative of the on or off state of said pressure detector.

2. The device of claim 1 wherein said controller is operable with a computing environment.

3. The device of claim 1 wherein said pressure sensor includes an analog pressure sensor and pulse generator.

4. The device of claim 1 wherein said controller is a control processor capable of handling data framing and sense and positional resolution.

5. The device of claim 1 wherein said pointing device includes a computer mouse.

6. The device of claim 5 wherein said pressure detector includes a mouse button.

7. The device of claim 6 wherein a light depression of said button triggers an off-state.

8. The device of claim 7 wherein an increased depression of said button provides an on-state.

9. The device of claim 8 wherein said on-state creates a rapid repeat click of the mouse button.

10. The device of claim 9 wherein a frequency of said rapid repeat click function increases in a manner proportional to an amount of pressure applied to said button.

11. The device of claim 1 wherein said controller is also in communication with an audio feedback component.

12. The device of claim 1 wherein said controller is also in communication with a tactile feedback component.

13. The device of claim 2 wherein said controller is operable to set minimum and maximum rates of said rate signal in accordance with a computer program interfacing with said controller.

14. The device of claim 2 wherein an interface mechanism is provided for establishing communication between said controller and the computing environment.

15. The device of claim 5 wherein said encoder is a directional encoder for detecting position of said pointing device in x and y directions.

16. The device of claim 1 wherein said pointing device is a portable computer mouse.

17. The device of claim 16 wherein said mouse is installed on a keyboard connected to the portable computer.

18. The device of claim 1 wherein said pointing device is a joystick.

19. The device of claim 1 wherein said encoder is a directional encoder for detecting rotational position of said joystick.

20. A method for providing enhanced user input using a pointing device comprising:
detecting a directional user input by an encoder;
detecting an amount of pressure exerted on said pointing device by a pressure circuit including a pressure sensor and a pressure detector having an off-state and an on-state;
sending signals from said encoder and said pressure circuit to a controller;
said controller outputting a rate signal varying in relation to an amount of pressure sensed by said pressure sensor and a signal indicative of the on or off state of said pressure detector.
